(19) United States
(12) Patent Application Publication
(10) Pub. No.: US 2014/0297100 A1
(43) Pub. Date: Oct. 2, 2014

(54) EMERGENCY REPORT SYSTEM

(71) Applicant: DENSO CORPORATION, Kariya-city (JP)

(72) Inventors: Nobuo Miura, Toyoake-city (JP); Makoto Sakai, Kariya-city (JP)

(73) Assignee: DENSO CORPORATION, Kariya-city (JP)

(21) Appl. No.: 14/227,317

(22) Filed: Mar. 27, 2014

(30) Foreign Application Priority Data
Mar. 29, 2013 (JP) 2013-073175

(51) Int. Cl. H04W 4/22; H04W 4/02

(52) U.S. Cl. CPC H04W 4/22; H04W 4/027
USPC 701/31.5

(57) ABSTRACT

An emergency report system includes a transmitter, a fixing member, and a portable terminal. The transmitter includes an accelerometer and a transmitting section, the accelerometer detects an acceleration of a vehicle, and the transmitting section transmits acceleration information including the acceleration detected by the accelerometer. The fixing member fixes the transmitter to a predetermined portion of the vehicle. The portable terminal includes a receiving section and a report section, the receiving section receives the acceleration information transmitted from the transmitting section, and the report section reports an emergency to a report destination preliminarily stored in the portable terminal based on the acceleration information.

### CROSS REFERENCE TO RELATED APPLICATION

This application is based on Japanese Patent Application No. 2013-073175 filed on Mar. 29, 2013, the disclosure of which is incorporated herein by reference.

### TECHNICAL FIELD

The present disclosure relates to an emergency report system that performs an emergency report when an acceleration greater than a threshold value is detected.

### BACKGROUND

JP 2002-032886 A discloses an example of a technology related to a portable traffic obstacle reporting terminal device that surely transmits an obstacle occurring place and an obstacle state when a traffic accident occurs. The portable traffic obstacle reporting terminal device includes an obstacle occurrence recognition device and an obstacle report device. The obstacle occurrence recognition device recognizes an occurrence of an obstacle in response to an impact greater than a predetermined value. When the obstacle occurrence recognition device recognizes the occurrence of the obstacle, the obstacle report device reports the obstacle by transmitting obstacle occurrence information to a phone number, which is preliminarily stored by a user, via a portable phone function.

The portable traffic obstacle reporting terminal device disclosed in JP 2002-032886 A is carried by the user. Thus, the portable traffic obstacle reporting terminal device may mistakenly transmit the obstacle occurrence information even though the user does not have a traffic accident. For example, when the user drops the portable traffic obstacle reporting terminal device, or when the portable traffic obstacle reporting terminal device is hit again a wall or a column, the portable traffic obstacle reporting terminal device may mistakenly report the obstacle by transmitting the obstacle occurrence information.

A G-sensor equipped to the portable traffic obstacle reporting terminal device is required to set to have a small detection range so that the portable traffic obstacle reporting terminal device is able to report the obstacle when the user has or meets the obstacle during a walking. When the user drives a vehicle with the portable traffic obstacle reporting terminal device kept on him or her, the portable traffic obstacle reporting terminal device may detect an apply of a sudden brake as an obstacle, and may report the obstacle by transmitting the obstacle occurrence information.

A function of the portable traffic obstacle reporting terminal device may be equipped to a vehicle. In this case, the vehicle is limited to a new vehicle that is being manufactured or is going to be manufactured.

### SUMMARY

In view of the foregoing difficulties, it is an object of the present disclosure to provide an emergency report system that is easily equipped to a vehicle and an emergency, such as a vehicle collision, is reliably reported to a predetermined report destination.

According to an aspect of the present disclosure, an emergency report system includes a transmitter, a fixing member, and a portable terminal. The transmitter includes an accelerometer and a transmitting section, the accelerometer detects an acceleration of a vehicle, and the transmitting section transmits acceleration information including the acceleration detected by the accelerometer. The fixing member fixes the transmitter to a predetermined portion of the vehicle. The portable terminal includes a receiving section and a report section, the receiving section receives the acceleration information transmitted from the transmitting section, and the report section reports, based on the acceleration information, an emergency to a report destination that is preliminarily stored in the portable terminal.

With the above system, the emergency report system is easily equipped to the vehicle and the emergency, such as a vehicle collision, is reliably reported to the report destination that is preliminarily stored in the portable terminal.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of an emergency report system according to an embodiment of the present disclosure;

FIG. 2 is a diagram showing a side view of a transmitter and a side view of a portable terminal according to a first embodiment of the present disclosure;

FIG. 3 is a flowchart showing an example of an information transmitting process executed by the transmitter and an example of an information report process executed by the portable terminal;

FIG. 4 is a flowchart showing an example of a report confirmation process executed by the portable terminal;

FIG. 5A and FIG. 5B are diagrams showing examples of an inquiry screen displayed on the portable terminal;

FIG. 6A and FIG. 6B are diagrams showing examples of a report destination selection screen displayed on the portable terminal;

FIG. 7A and FIG. 7B are diagrams showing examples of a report destination screen displayed on the portable terminal;

FIG. 8 is a diagram showing an example of an emergency notifying screen displayed on the report destination;

FIG. 9 is a diagram showing a side view of a transmitter and a side view of a portable terminal according to a second embodiment of the present disclosure;

FIG. 10 is a diagram showing an example of the transmitter having multiple accelerometers according to a third embodiment of the present disclosure;

FIG. 11 is a diagram showing an example of a disposing position of the transmitter; and

FIG. 12 is a diagram showing a side view of a transmitter according to another embodiment.

### DETAILED DESCRIPTION

The following will describe embodiments of the present disclosure with reference to accompanying drawings. Further, in the following description, “connect” and “connection” mean “electrically connect” and “electrical connection”, respectively, unless otherwise specified. Each drawing illustrates components that are necessary to describe a configuration of the present disclosure, and the components of the present disclosure are not limited to the illustrated ones.

### First Embodiment

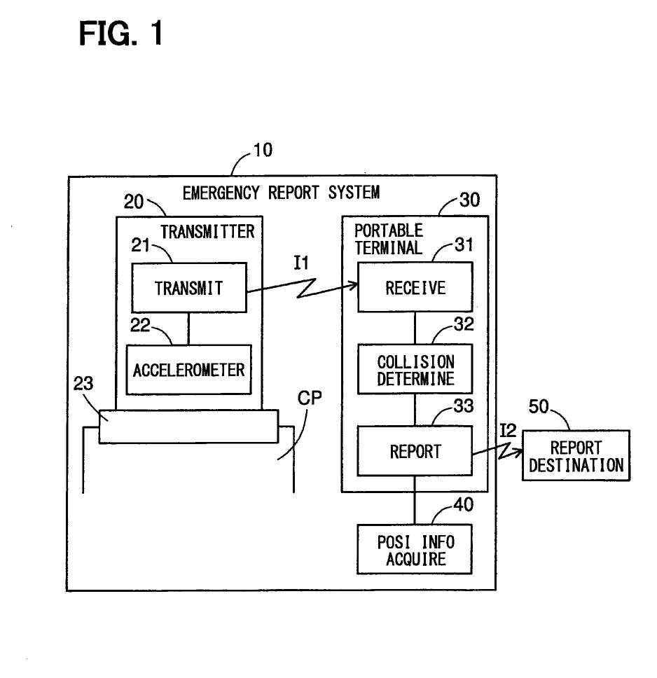

The following will describe an emergency report system 10 according to a first embodiment of the present disclosure with reference to FIG. 1 to FIG. 7B. As shown in FIG. 1, the emergency report system 10 includes a transmitter 20, a portable terminal 30, and a position information acquiring section (POSI INFO ACQUIRE) 40.

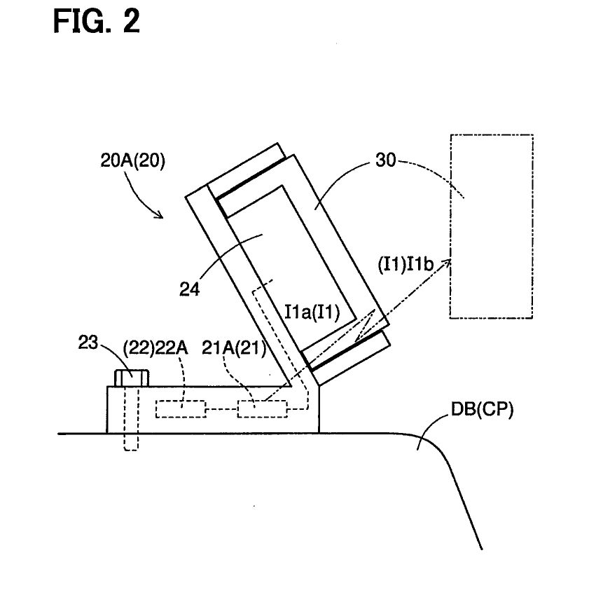

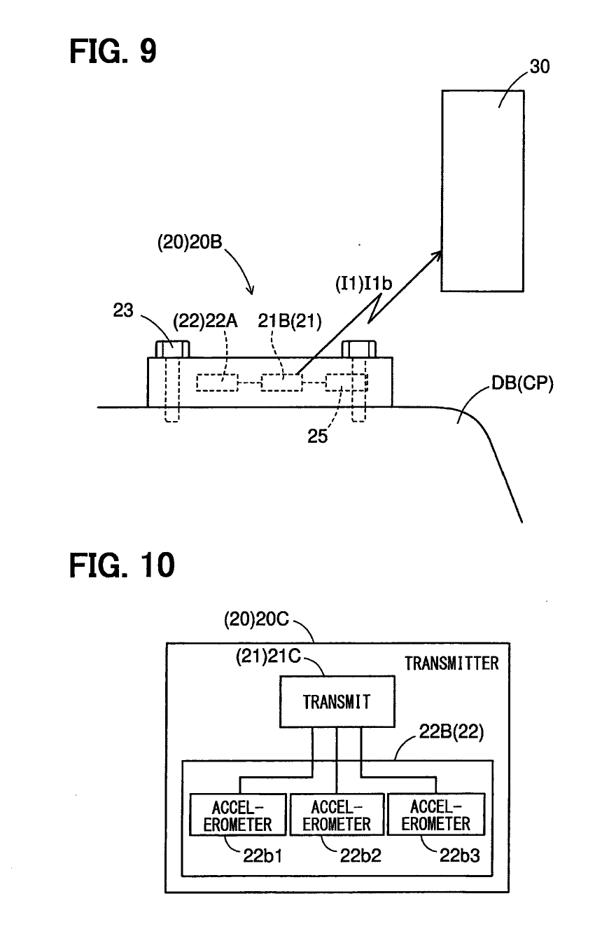

The transmitter 20 includes a transmitting section (TRANSMIT) 21, an accelerometer 22, and a fixing member 23. The fixing member 23 fixes the transmitter 20 to a predetermined portion CP of a vehicle 100. A power of the transmitting section 21 may be supplied by a vehicle battery, which mainly utilizes a secondary battery. The power of the transmitting section 21 may also be supplied by a solar cell, a dry battery or the like. The following will describe a fixing example of the transmitter 20 with reference to FIG. 2 and FIG. 9. The transmitter 20 may be fixed to a vehicle that has been manufactured, such as a sold vehicle or an existing vehicle. The transmitter 20 may also be fixed to a vehicle during a manufacturing process.

The portable terminal 30 includes a receiving section (RECEIVE) 31, a collision determination section (COLLISION DETERMINE) 32, and a report section (REPORT) 33. The portable terminal 30 may be provided by a terminal device that is able to be carried by a user. For example, the portable terminal 30 may be provided by a mobile phone, a tablet terminal, a portable information terminal device or the like. The receiving section 31 may employ a function of the portable terminal 30, such as executing an application or a program. The report section 33 may employ a function of the portable terminal 30, such as executing an application or a program. Both the receiving section 31 and the report section 33 may employ a function of the portable terminal 30, such as executing an application or a program. Among the receiving section 31, the collision determination section 32 and the report section 33, at least the collision determination section 32 may be installed in the portable terminal 30 as an application program by executing a predetermined operation by the user. Among the receiving section 31, the collision determination section 32 and the report section 33, at least the collision determination section 32 may be originally included in the portable terminal 30.

In FIG. 2, a transmitter 20A is an example of the transmitter 20 shown in FIG. 1. The transmitter 20A shown in FIG. 2 includes a transmitting section 21A and an accelerometer 22A. The accelerometer 22A is an example of the accelerometer 22 shown in FIG. 1, and detects an acceleration of the vehicle 100. The accelerometer 22A may be provided by a single-axis accelerometer that detects an acceleration along an X axis, a two-axis accelerometer that detects accelerations along the X axis and a Y axis perpendicular to the X axis, or a three-axis accelerometer that detects accelerations along the X axis, the Y axis, and a Z axis perpendicular to the X axis and the Y axis. When the accelerometer 22A is provided by the two-axis accelerometer, the accelerometer 22A is able to detect a vehicle collision in a front-rear direction of the vehicle 100 and a vehicle collision in a left-right direction of the vehicle 100. When the accelerometer 22A is provided by the three-axis accelerometer, a detection accuracy of the vehicle collision can be improved.

The transmitting section 21A is an example of the transmitting section 21 shown in FIG. 1, and transmits acceleration information I1 including the acceleration detected by the accelerometer 22A. In the present embodiment, the transmitting section 21A performs both a wire communication and a wireless communication. The transmitting section 21A may communicate with an electronic control unit (ECU) of the vehicle 100 and an automotive navigation system of the vehicle 100. In a case where the transmitting section 21A is able to obtain position information of the vehicle 100, the transmitting section 21A may transmit the position information of the vehicle 100 together with the acceleration information IL The transmitting section 21A may include the position information of the vehicle 100 in the acceleration information I1, and transmits the position information together with the acceleration information I1.

The predetermined portion CP of the vehicle 100 may be provided by a dashboard DB of the vehicle 100 as an example, and the transmitter 20A may be fixed to the dashboard DB of the vehicle 100 via the fixing member 23. In FIG. 2, the fixing member 23 is provided by a fastener, such as a bolt or a screw. The transmitter 20A may also be fixed to the dashboard DB of the vehicle 100 by soldering or arc welding. The transmitter 20A may also be adhered to the dashboard DB of the vehicle 100 by an adhesive. The fixing member 23 is not limited to the above-described members. Under a condition that the transmitter 20A is fixed to the vehicle 100 so that the acceleration of the vehicle 100 is applied to the transmitter 20A, the fixing member 23 may be provided by a different member.

In the present embodiment, the transmitter 20A further includes a terminal holder 24 that holds the portable terminal 30. The terminal holder 24 may be provided by a well-known cradle. In FIG. 2, the terminal holder 24 holds the portable terminal 30 as shown by a solid line or releases the portable terminal 30 as shown by a two dotted chain line. When the portable terminal 30 is held by the terminal holder 24, the transmitting section 21A is communicably connected with the receiving section 31 as shown by a dashed line in FIG. 2. In this case, the transmitting section 21A performs the wire communication with the receiving section 31. When the transmitting section 21A is wire-communicably connected with the receiving section 31, the transmitting section 21A transmits the acceleration information I1a via a wire signal to the portable terminal 30. The transmitting section 21A and the receiving section 31 may perform the wire communication based on a wire communication protocol. The wire communication protocol may be a serial communication, such as RS-232 or IEEE 1394, a parallel communication, such as Peripheral Components Interconnect (PCI) or IEEE 488, an Ethernet (registered trademark) or the like.

When the portable terminal 30 is removed from the terminal holder 24, the transmitting section 21A is communicably connected with the receiving section 31 as shown by a two dotted chain line in FIG. 2. In this case, the transmitting section 21A performs the wireless communication with the receiving section 31. When the transmitting section 21A is wireless-communicably connected with the receiving section 31, the transmitting section 21A transmits the acceleration information I1b via a wireless signal to the portable terminal 30. The transmitting section 21A and the receiving section 31 may perform the wireless communication based on a wireless communication protocol. The wireless communication protocol may be a Bluetooth (registered trademark), a wireless local area network (LAN), such as a Wi-Fi (registered trademark), or an optical wireless communication, such as IrDA (registered trademark).

As described above, the portable terminal 30 includes the receiving section 31, the collision determination section 32, and the report section 33. The receiving section 31 receives the acceleration information I1 transmitted from the transmitting section 21A. Herein, the acceleration information I1 is one of the acceleration information I1a transmitted via the wire signal and the acceleration information I1b transmitted via the wireless signal. The collision determination section 32 determines whether the vehicle collision has occurred based on the acceleration information I1 received by the receiving section 31. The collision determination section 32 may determine whether the vehicle collision has occurred by determining whether the acceleration included in the acceleration information I1 is greater than a threshold value. Here, the threshold value is set greater than a brake acceleration detected when a brake is applied to the vehicle 100. The report section 33 performs an emergency report to a report destination 50. The report destination 50 is one or more person or facility to be notified of the emergency. Contact information of the report destination 50 is preliminarily stored in the portable terminal 30. The report destination 50 may be preliminarily stored by the user. The report destination 50 may be set to a family member, a relative, a friend, or an acquaintance. For example, an emergency center (in Japan, contact number is 119), a fire station (in Japan, contact number is 119), or a police (in Japan, contact number is 110) may also be set as the report destination 50. As another example, the emergency center, the fire station, or the police may also be not set as the report destination 50. The report section 33 may perform the emergency report by transmitting a text, a symbol, a sound message, an image, or a video to the report destination 50. In a case where the report section 33 performs the report to the emergency center, the fire station, or the police, the report is preferred to be performed by sending a sound message. During the portable terminal 30 is held by the terminal holder 24, the receiving section 31 and the report section 33 may be configured to keep in an operating state even though a power of the portable terminal 30 is turned off.

The emergency report system 10 may further include the position information acquiring section 40 as necessary. The position information acquiring section 40 acquires the position information indicating a present position of the vehicle 100. The position information acquiring section 40 may acquire the position information of the vehicle 100 based on global positioning system (GPS) information provided by the transmitter 20 that has a GPS function. The position information acquiring section 40 may acquire the position information of the vehicle 100 based on GPS information provided by the portable terminal 30 that has a GPS function. The position information acquiring section 40 may acquire the position information of the vehicle 100 based on GPS information provided by the automotive navigation system that has a GPS function. The position information acquiring section 40 may acquire the position information of the vehicle 100 based on GPS information provided by other devices having GPS functions. The position information acquiring section 40 may acquire the position information of the vehicle 100 from a device or a component that is able to detect the present position of the vehicle 100. The present embodiment will representatively describe an example in which the position information acquiring section 40 acquires the position information based on the GPS information provided by the portable terminal 30 that has the GPS function.

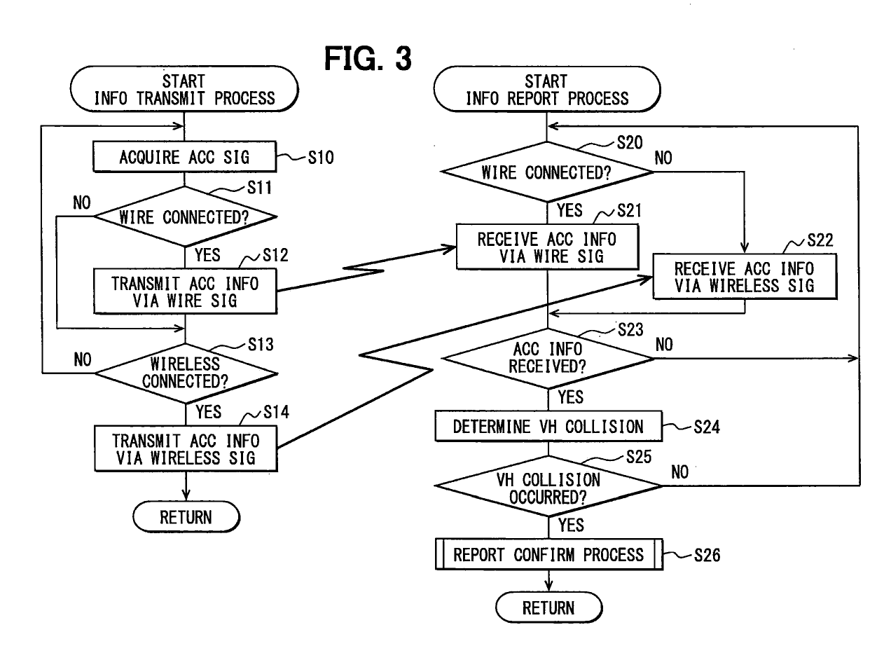

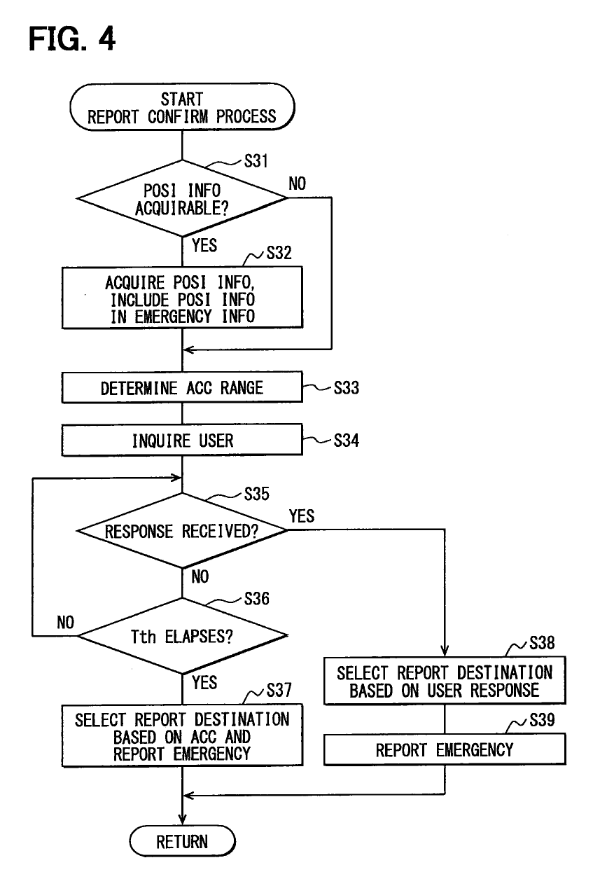

The following will describe a process executed by the emergency report system 10 with reference to FIG. 3 and FIG. 4.

It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

FIG. 3 shows an example of an information transmit process executed by the transmitter 20 and an example of an information report process executed by the portable terminal 30. FIG. 4 shows an example of a report confirmation process executed by the portable terminal 30. Processes executed at S12, S14 function as the transmitting section 21. Processes executed at S21, S22 function as the receiving section 31. A process executed at S24 functions as the collision determination section 32. Processes executed at S34 to S39 function as the report section 33.

As shown in FIG. 3, when the transmitter 20 starts the information transmit process, the accelerometer 22 transmits an acceleration signal (ACC SIG) including the acceleration Gd of the vehicle 100 to the transmitting section 21 at S10. That is, the transmitting section 21 acquires the acceleration signal from the accelerometer 22. At S11, the transmitter 20 determines whether the portable terminal 30 is communicable connected with transmitter 20 in a wire manner. When the portable terminal 30 is held by the terminal holder 24 of the transmitter 20, that is the portable terminal 30 is communicably connected with the transmitter 20 in a wire manner (S11: YES), the transmitting section 21 transmits the acceleration information (ACC INFO) I1a including the acceleration Gd of the vehicle 100 via the wire signal at S12. At S11, when the transmitter 20 determines that the portable terminal 30 is not held by the terminal holder 24 of the transmitter 20, that is the portable terminal 30 is not communicably connected with the transmitter 20 in a wire manner (S11: NO), the transmitter 20 further determines whether the portable terminal 30 is communicably connected with transmitter 20 in a wireless manner at S13. When the portable terminal 30 is removed from the terminal holder 24 of the transmitter 20, that is the portable terminal 30 is communicably connected with the transmitter 20 in a wireless manner (S13: YES), the transmitting section 21 transmits the acceleration information (ACC INFO) I1b including the acceleration Gd of the vehicle via the wireless signal at S14. In the present embodiment, the transmitter 20 repeatedly executes S10 to S14.

As shown in FIG. 3, the portable terminal 30 executes the information report process corresponding to the information transmit process executed by the transmitter 20. When the portable terminal 30 starts the information report process, the portable terminal 30 determines whether the portable terminal 30 is held by the terminal holder 24 of the transmitter 20 at S20. When the portable terminal 30 determines that the portable terminal 30 is wire-communicably connected with the transmitter 20 (S20: YES), that is the portable terminal 30 is held by the terminal holder 24 of the transmitter 20, the portable terminal 30 receives the wire signal transmitted from the transmitter 20 at S21. When the portable terminal 30 determines that the portable terminal 30 is wireless-communicably connected with the transmitter 20 (S20: NO), that is the portable terminal 30 is removed from the terminal holder 24 of the transmitter 20, the portable terminal 30 receives the wireless signal transmitted from the transmitter 20 at S22.

At S23, the portable terminal 30 determines whether the acceleration information I1, I1a, I1b is successfully received via the wire signal or the wireless signal. When the portable terminal 30 determines that the acceleration information I1, I1a, I1b is successfully received (S23: YES), the portable terminal 30 further determines whether the vehicle collision (VH COLLISION) has occurred based on the acceleration information I1 at S24. Specifically, the portable terminal 30 determines whether the vehicle collision has occurred by determining whether the acceleration Gd included in the acceleration information I1 is greater than a reference value G1. Herein, the reference value G1 functions as a reference based on which an occurrence of the vehicle collision has occurred or not, and corresponds to the threshold value. When the portable terminal 30 determines that the acceleration Gd is smaller than the threshold value G1 (Gd<G1), the portable terminal 30 determines that no vehicle collision has occurred. When the portable terminal 30 determines that the acceleration Gd is equal to or greater than the threshold value G1 (Gd>=G1), the portable terminal 30 determines that the vehicle collision has occurred. The threshold value G1 may be set within a range from several ten gravity accelerations to several hundred gravity accelerations. For example, the threshold value G1 may be set within a range from 20 gravity accelerations to 200 gravity accelerations. When the portable terminal 30 determines that the vehicle collision has occurred (S25: YES), the portable terminal 30 executes a report confirmation process at S26. When the portable terminal 30 determines that the vehicle collision has not occurred (S25: NO), the portable terminal 30 returns to S20. In the present embodiment, the portable terminal 30 repeatedly executes S20 to S26.

In the report confirmation process shown in FIG. 4, the portable terminal 30 determines whether the position information (POSI INFO) of the vehicle 100 is acquirable at S31. When the position information is included in the acceleration information I1 or the position information is acquirable by the position information acquiring section 40 (S31: YES), the portable terminal 30 acquires the position information, and includes the position information to emergency information. Herein, the emergency information is information to be reported to the report destination 50 by the portable terminal 30. The position information may include latitude, longitude and altitude of the present position of the vehicle 100. The position information may include an address (in Japan, details of prefecture, city, district or village) of the present position of the vehicle 100. The position information may be map data indicating the present position of the vehicle 100. The position information may be an image or a video that specifies the present position of the vehicle 100. The image or the video may be provided by pictures taken by a camera equipped to the portable terminal 30 or a camera equipped to the vehicle 100. The image or the video may also be obtained via an internet network. Under a condition that the present position of the vehicle 100, that is the position of the vehicle collision, can be easily specified, the position information may be provided by any information.

At S33, the portable terminal 30 determines a scale (or a state) of the vehicle collision based on the acceleration Gd included in the acceleration information I1 obtained at S21. For example, the portable terminal 30 determines the scale of the vehicle collision based on the following table 1.

TABLE 1

| | | DISPLAY ON |
|---|---|---|
| | REPORT | REPORT |
| RANGE | DESTINATION | DESTINATION |
| Gd < G1 | NO REPORT | — |
| G1 ≦ Gd < G2 | FAMILY MEMBER | ACCELERATION |
| G2 ≦ Gd < G3 | FAMILY MEMBER, | HIGH |
| | FRIEND, ACQUAINTANCE | ACCELERATION |
| G3 ≦ Gd | FAMILY MEMBER, | SUPER HIGH |
| | FRIEND, ACQUAINTANCE | ACCELERATION |
| | EMERGENCY CENTER, | |
| | POLICE | |

In table 1, reference values G1, G2, G3 may be properly set under a condition that G1<G2<G3. Each of the reference values G2, G3 may be properly set within a range from several ten gravity accelerations to several hundred gravity accelerations satisfying the condition G1<G2<G3. As shown in table 1, the report destination 50 is set differently according to the detected acceleration Gd of the vehicle 100, and each report destination 50 may include one or more persons (facilities) corresponding to the detected acceleration Gd of the vehicle 100. Table 1 shows three different report destinations 50 corresponding to three different range groups of the acceleration Gd. The acceleration Gd may also be divided into multiple range groups other than three.

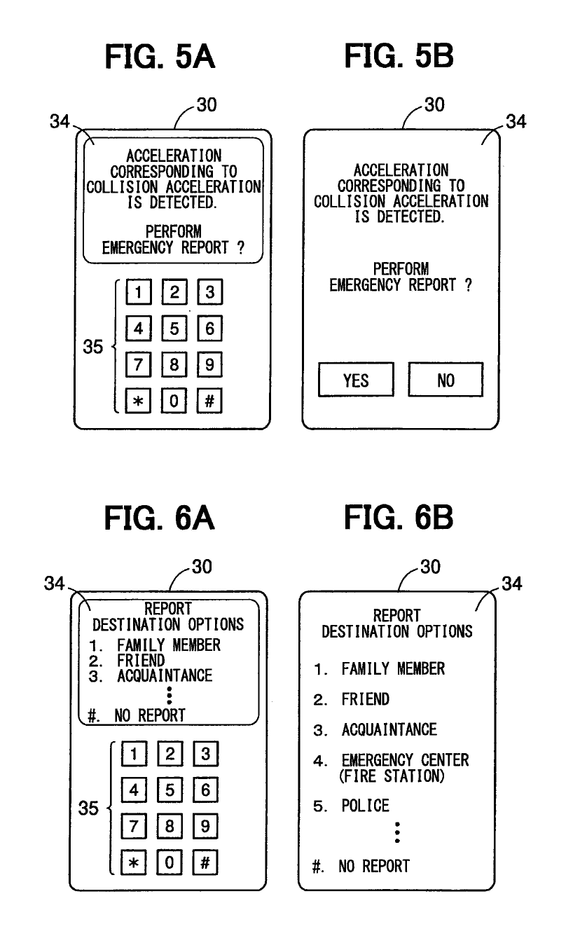

At S34, based on a determination result at S33, the portable terminal 30 performs an inquiry to the user so that the user is able to determine whether to report the vehicle collision as the emergency to the report destination 50. Here, the report destination is specified at S33 based on a value of the acceleration Gd. For example, as shown in FIG. 5A and FIG. 5B, the portable terminal 30 performs the inquiry to the user by displaying an inquiry screen on a display device 34 or outputting an audio signal, such as a sound message or a notifying sound, to the user, and waits for a response from the user. The inquiry may be performed by only displaying the inquiry screen on the display device 34. The inquiry may be performed by only outputting the audio signal. The inquiry may be performed by other methods. FIG. 5A is an example of the inquiry screen displayed on the display device 34 of the portable terminal 30 having a keyboard 35 as an operation section. FIG. 5B is an example of the inquiry screen displayed on the display device 34 of the portable terminal 30 provided by a smart phone or a tablet terminal. In this case, the display device 34 functions as an operation section. The following will describe performing the inquiry by displaying the inquiry screen on the display device 34 as an example.

The user, who is also a vehicle occupant, may select to perform the emergency report to the report destination 50 or not to perform the emergency report. That is, the portable terminal 30 performs the inquiry to the user so that the user is able to determine whether to report the emergency to the report destination 50 or not. At S35, the portable terminal 30 determines whether a response is made by the user of the portable terminal 30 by operating the operation section. At S36, the portable terminal 30 determines whether an allowable response period (Tth) has elapsed from the inquiry screen is displayed on the display device 34. That is, the portable terminal 30 determines whether the response is made within the allowable response period. The allowable response period may be properly set, such as 10 seconds or one minute. During the allowable response period, the display screen shown in FIG. 5A or FIG. 5B is displayed to the user. When the portable terminal 30 receives the response from the user within the allowable response period (S35: YES), the user is considered to be conscious. At S38, the portable terminal 30 selects the report destination 50 based on the response of the user. At S39, the portable terminal 30 performs the emergency report to the report destination 50, which is selected at S38. Then, the portable terminal 30 ends the report confirmation process and returns to S20. In some cases, a witness who passes by may receive the inquiry instead of the vehicle occupant of the vehicle 100. Further, the witness may select the report destination 50 instead of the user.

When the user is inquired by the portable terminal 30 about the report destination 50 as shown in FIG. 5A and FIG. 5B, the user may select one report destination 50 as the response to the inquiry. For example, the portable terminal 30 may display a text message, such as “Acceleration corresponding to collision acceleration is detected. Perform emergency report ?” on the display device 34. The user is able to select the report destination 50 by pressing a button of the operation section in FIG. 5A or touching the display device 34 in FIG. 5B. The portable terminal 30 selects the report destination 50 based on the selection made by the user. FIG. 6A, which corresponds to FIG. 5A, shows a display screen that displays report destination options to the user. FIG. 6B, which corresponds to FIG. 5B, shows a display screen that displays report destination options to the user. At S39, the portable terminal 30 performs the emergency report to the report destination 50 selected by the user from the report destination options. When the user selects to report the emergency to the report destination 50 other than the family member, the portable terminal 30 may be configured to include private information of the user in the emergency information. Herein, the private information may include a name of an owner of the portable terminal 30, such as the name of the user. When the portable terminal 30 fails to receive the response from the user within the allowable response period, as shown in table 1, the portable terminal 30 may set the report destination 50 differently according to the acceleration Gd included in the acceleration information IL The portable terminal 30 may include vehicle related information, such as vehicle manufacturer, vehicle name, vehicle number, body color, in the emergency information in order that the person or the facility who receives the emergency information can easily specify the vehicle 100.

When the portable terminal fails to receive the response from the user within the allowable response period (S35: NO, S36: YES), it is highly possible that the user is unconscious due to the vehicle collision. Thus, at S37, the portable terminal 30 selects the report destination 50 corresponding to the acceleration Gd based on the determination result at S33, and performs the emergency report to the selected report destination 50. Then, the portable terminal 30 ends the report confirmation process and returns to S20. When reporting the emergency to the report destination 50, the portable terminal 30 may include the acceleration Gd of the vehicle 100 as the collision scale in the emergency information.

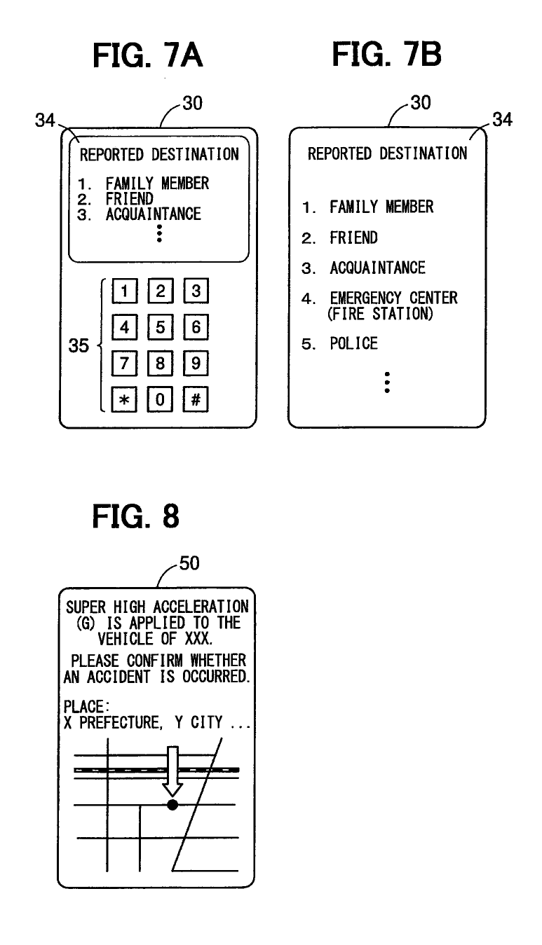

In the above-described S37, S39, after the portable terminal 30 reports the emergency to the report destination 50, the portable terminal 30 may display specific information of the report destination 50 to which the emergency report has been performed on the display device 34 of the portable terminal 30. With this configuration, the report destination 50 to which the emergency report has been performed is easily known. FIG. 7A, which corresponds to FIG. 5A, shows the reported destination to which the emergency report has been performed. FIG. 7B, which corresponds to FIG. 5B, shows the reported destination to which the emergency report has been performed. When the report destination 50 receives the emergency information from the portable terminal 30 via S37, S39, a display screen showing the emergency information is displayed to a user, a holder, or a charger of the report destination 50 as shown in FIG. 8. Specifically, the message “Super high acceleration G is applied to the vehicle of XXX. Please confirm whether an accident is occurred. Place: X Prefecture, Y city . . . ” may be displayed on the report destination 50. In the example shown in FIG. 8, the emergency information includes the name “XXX”, the acceleration “G”, and a map indicating the position of the emergency. That is, information indicating “who”, “how big impact is occurred (the acceleration)” is reported to the report destination 50. Thus, necessary measures can be taken immediately and properly by the user, the holder, or the charger of the report destination 50. Instead of displaying the report destination options on the display device 34 of the portable terminal 30, the portable terminal 30 may output the report destination options via a sound message. At the report destination 50, instead of displaying the emergency information on a display device, the emergency information may be output by a sound message to the user, the holder, or the charger of the report destination 50.

The following will describe advantages provided by the emergency report system 10 according to the present embodiment.

As shown in FIG. 1 and FIG. 2, the emergency report system 10 according to the present embodiment includes the transmitter 20A, the fixing member 23, and the portable terminal 30. The transmitter 20A includes the accelerometer 22A and the transmitting section 21A. The accelerometer 22A detects the acceleration of the vehicle 100. The transmitting section 21A transmits the acceleration information I1 including the acceleration detected by the accelerometer 22A. The acceleration information I1 is one of the acceleration information I1a transmitted via the wire signal and the acceleration information I1b transmitted via the wireless signal. The fixing member 23 fixes the transmitter 20A to the predetermined portion CP of the vehicle 100 that has been manufactured. The portable terminal 30 includes the receiving section 31 and the report section 33. The receiving section 31 receives the acceleration information I1 transmitted from the transmitting section 21A of the transmitter 20A. The report section 33 reports the emergency to the report destination 50 based on the acceleration information I1. The report destination 50 is preliminarily stored in the portable terminal 30.

With above-described configuration, the transmitter 20A can be easily equipped to the predetermined portion CP of the vehicle 100 by the fixing member 23. Particularly, when the vehicle 100 is a ready-made vehicle, the transmitter 20A can be easily equipped to the vehicle 100. The report section 33 reports the emergency to the preliminarily stored report destination 50 based on the acceleration information I1. Thus, when a collision of the vehicle 100 occurs, the vehicle collision can be immediately reported to the preliminarily stored report destination 50, and a necessary measure can be taken by the user, the holder, or the charger of the report destination 50. For example, the user, the holder, or the charger of the report destination 50 may report the emergency to the emergency center, the police, a related facility or the like.

In the present embodiment, the portable terminal 30 includes the collision determination section 32. The collision determination section 32 determines the vehicle collision (S24 in FIG. 3) as the emergency when the acceleration included in the acceleration information I1 is greater than the threshold value G1. The threshold value G1 is set greater than the brake acceleration that is detected when the brake is applied to the vehicle 100. With this configuration, a detection accuracy of the vehicle collision can be improved by eliminating accelerations equal to or lower than the brake acceleration.

The report section 33 inquires of the vehicle occupant whether to report the emergency to the report destination 50. Then, the report section 33 reports the emergency to the report destination 50 based on a presence or an absence of the response from the vehicle occupant (S34 to S39 in FIG. 4). Specifically, when the portable terminal 30 receives the response within the allowable response period from the user, the report section 33 reports the emergency to the report destination 50 selected by the user. When the portable terminal 30 fails to receive the response from the user within the allowable response period, the report section 33 reports the emergency to the report destination 50 corresponding to the detected acceleration Gd. With this configuration, the report section 33 does not report the emergency when the user selects to not perform the emergency report. That is, when the emergency report is not necessary, the report section 33 cancels the emergency report. When no response is made by the user, who is also the vehicle occupant, the vehicle occupant is highly possible to get injured heavily by the vehicle collision. Thus, when no response is made by the vehicle occupant within the allowable response period, the report section 33 reports the emergency to the report destination 50 that is set corresponding to the acceleration. Thus, unnecessary emergency report can be avoided, and at the same time, the emergency report is performed properly and immediately when the vehicle occupant needs a first aid.

The report section 33 reports the emergency to the report destination 50 selected based on the response of the vehicle occupant to the inquiry (S34 to S39 in FIG. 4). With this configuration, the emergency is reported only to the report destination 50 selected by the vehicle occupant or selected by the witness of the vehicle collision. Thus, the number of emergency reporting times can be reduced to a necessary minimum value.

As shown in FIG. 2, the predetermined portion CP of the vehicle 100 is a predetermined portion, such as the dashboard DB, disposed in a compartment of the vehicle 100. With this configuration, the transmitter 20A is easily fixed to the dashboard DB of the vehicle 100, and easily communicate with the portable terminal 30.

The transmitter 20A includes the terminal holder 24 that holds the portable terminal 30. When the portable terminal 30 is held by the terminal holder 24, the transmitting section 21A of the transmitter 20A is communicably connected with the portable terminal 30. With this configuration, the communication between the transmitting section 21A and the portable terminal 30 can be easily and reliably set up by only keeping the portable terminal 30 held by the terminal holder 24.

During the portable terminal 30 is held by the terminal holder 24, the receiving section 31 and the report section 33 keep work in the operating state even though the power of the portable terminal 30 is turned off (FIG. 2 and FIG. 3). With this configuration, the emergency is reliably reported to the report destination 50 even though the power of the portable terminal 30 is turned off. Since the receiving section 31 and the report section 33 keep work in the operating state when the portable terminal 30 is held by the terminal holder 24, the power of the portable terminal 30 is not necessarily to be turned on during the portable terminal 30 is being held by the terminal holder 24.

The transmitting section 21A performs the wire communication with the portable terminal 30 when the portable terminal 30 is held by the terminal holder 24. The transmitting section 21A performs the wireless communication with the portable terminal 30 when the portable terminal 30 is removed from the terminal holder 24 (FIG. 2 and S11 to S14 in FIG. 3). With this configuration, an external noise can be reduced when the transmitting section 21A performs the wire communication with the portable terminal 30. When the portable terminal 30 is removed from the terminal holder 24, the transmitting section 21A can transmit the acceleration information I1 to the portable terminal 30 by the wireless communication.

In the present embodiment, the emergency report system 10 may further include the position information acquiring section 40 that acquires the position information indicating the present position of the vehicle 100. The report section 33 reports the position information acquired by the position information acquiring section 40 to the report destination 50 (S31, S32 in FIG. 4). When the position information is reported to the report destination 50, the position at which the vehicle collision has occurred can be reported to the report destination 50. Thus, the person who is notified of the emergency, such as the family member, can arrive at the position of the vehicle collision in a hurry.

### Second Embodiment

The following will describe a second embodiment of the present disclosure with reference to FIG. 9. The following will describe a part of the emergency report system 10 according to the present embodiment, which is different from the emergency report system 10 according to the first embodiment. The same reference number or reference symbol is used for the same or equivalent part with the first embodiment.

As shown in FIG. 9, the emergency report system 10 includes a transmitter 20B instead of the transmitter 20A of the first embodiment. The transmitter 20B is another example of the transmitter 20 shown in FIG. 1. The transmitter 20B includes a transmitting section 21B, but does not include the terminal holder 24 described in the first embodiment. In the present embodiment, the transmitting section 21B has the wireless communication function. That is, the transmitter 20B only performs the wireless communication with the portable terminal 30, and does not perform the wire communication with the portable terminal 30. Thus, in the emergency report system 10 according to the present embodiment, the processes executed at S11 to S13 of FIG. 3 in the information transmit process and processes executed at S20, S21 of FIG. 3 in the information report process are not necessary, and are skipped.

When the transmitter 20B performs the wireless communication with the portable terminal 30, the user may fail to hear or may feel hard to hear an audio signal notifying of the user about the inquiry or the an inquiry sound message if the portable terminal 30 is placed in a bag or a pocket of the user. Thus, the transmitter 20B may include an audio section 25, and the audio section 25 of the transmitter 20B may output the audio signal to the user. In this case, the audio section 25 may be provided by a voice synthesizing circuit or a speaker. The transmitter 20B may include a light emitting member that emits light to notify the user to respond to the inquiry. In this case, the light emitting member may be provided by a lamp or a light emitting diode. The emitting of the light includes continuous emitting of the light and intermittent emitting of the light. The report confirmation may be carried out by a different method under a condition that the inquiry reliably attracts an attention of the user.

The following will describe advantages provided by the emergency report system 10 according to the present embodiment. Advantages similar to the advantages provided by the emergency report system 10 according to the first embodiment are provided by the emergency report system 10 according to the present embodiment. Further, in the present embodiment, a size of the emergency report system 10 can be reduced since the transmitter 20B does not include the terminal holder 24. Thus, the transmitter 20B is more easily equipped to the predetermined portion CP of the vehicle 100.

In the present embodiment, as shown in FIG. 9, the transmitter 20B includes the audio section 25 that outputs the audio signal. Alternatively, the audio section 25 may also be equipped to the transmitter 20A according to the first embodiment. With the audio section 25, when the audio signal or the sound message output from the portable terminal 30 is hard to be heard by the user, for example, even though the portable terminal 30 is placed in a box, a bag, a pocket or a container, the emergency report system 10 can reliably perform the inquiry to the user by outputting the audio signal or the sound message from the audio section 25.

### Third Embodiment

The following will describe a third embodiment of the present disclosure with reference to FIG. 10. Only a part of the emergency report system 10 of the present embodiment, which is different from the emergency report system 10 according to the first embodiment, will be described. The same reference number or reference symbol is used for the same or equivalent part with the first embodiment.

As shown in FIG. 10, the emergency report system 10 includes a transmitter 20C instead of the transmitter 20A of the first embodiment. The transmitter 20C is another example of the transmitter 20 shown in FIG. 1. The transmitter 20C includes a transmitting section 21C and an accelerometer section 22B. The accelerometer section 22B includes multiple accelerometers 22b1, 22b2, 22b3 as shown in FIG. 10. When one of the accelerometers 22b1, 22b2, 22b3 fails to operate properly, that is a failure occurs, other accelerometers can alternatively detect the acceleration of the vehicle 100. Thus, a reliability of acceleration detection can be improved. The number of axes in each of the accelerometers 22b1, 22b2, 22b3 can be set as necessary. For example, each of the accelerometers 22b1, 22b2, 22b3 may have the same number of axes. For another example, each of the accelerometers 22b1, 22b2, 22b3 may have different number of axes from one another.

A detection range of each of the accelerometers 22b1, 22b2, 22b3 can be set as necessary. For example, the detection range of each of the accelerometers 22b1, 22b2, 22b3 may be set equal to one another. For another example, the detection range of each of the accelerometers 22b1, 22b2, 22b3 may be set different from one another. When the detection range of each of the accelerometers 22b1, 22b2, 22b3 is set different from one another, the detection range of each of the accelerometers 22b1, 22b2, 22b3 may be set totally different from one another so that the detection range of one of the accelerometers 22b1, 22b2, 22b3 has no common range with one another. When the detection range of each of the accelerometers 22b1, 22b2, 22b3 is set different from one another, the detection range of each of the accelerometers 22b1, 22b2, 22b3 may be set partially different from one another so that the detection range of one of the accelerometers 22b1, 22b2, 22b3 has partial common range with one another.

The transmitting section 21C is an example of the transmitting section 21 shown in FIG. 1, and transmits the acceleration information I1 including at least one of the accelerations detected by respective accelerometers 22b1, 22b2, 22b3. The acceleration information I1 may include all of the accelerations detected by respective accelerometers 22b1, 22b2, 22b3. The acceleration information I1 may include only one acceleration detected by one of the accelerometers 22b1, 22b2, 22b3. The acceleration information I1 may include two or more accelerations detected by two or more of the accelerometers 22b1, 22b2, 22b3. Further, the transmitting section 21C may include an average value of two or more accelerations detected by two or more of the accelerometers 22b1, 22b2, 22b3 in the acceleration information I1, and transmits the acceleration information I1 including the average value of the two or more accelerations. The acceleration information I1 does not include the acceleration detected by the accelerometer that has a failure. A determination of the operation failure in the accelerometer 22b1, 22b2, 22b3 may be set properly. For example, when the acceleration detected by one of the accelerometers 22b1, 22b2, 22b3 is greater or smaller than the acceleration detected by another one of the accelerometers 22b1, 22b2, 22b3 by a predetermined value or more, one of the two accelerometers 22b1, 22b2, 22b3 may be determined to have the operation failure in operation.

The following will describe advantages provided by the emergency report system 10 according to the present embodiment. Advantages similar to the advantages provided by the emergency report system 10 according to the first embodiment are provided by the emergency report system 10 according to the present embodiment.

In the present embodiment, the emergency report system 10 includes the accelerometer section 22B, which includes multiple accelerometers 22b1, 22b2, 22b3. As shown in FIG. 10, the transmitting section 21 transmits the acceleration information I1 including one of the accelerations detected by the multiple accelerometers 22b1, 22b2, 22b3. With this configuration, the detection reliability of the acceleration is secured. That is, the acceleration can be reliably detected by one of the multiple accelerometers 22b1, 22b2, 22b3 except only when all of the accelerometers 22b1, 22b2, 22b3 have operation failures. In the present embodiment, the accelerometer section 22B includes three accelerometers 22b1, 22b2, 22b3 as shown in FIG. 10. The accelerometer section 22B may also include two, four or more than four accelerometers. When the accelerometer section 22B includes multiple accelerometers, a reliability of reporting the emergency, such as the vehicle collision, to the report destination 50 is improved.

### Other Embodiments

The following will describe other embodiments of the present disclosure.

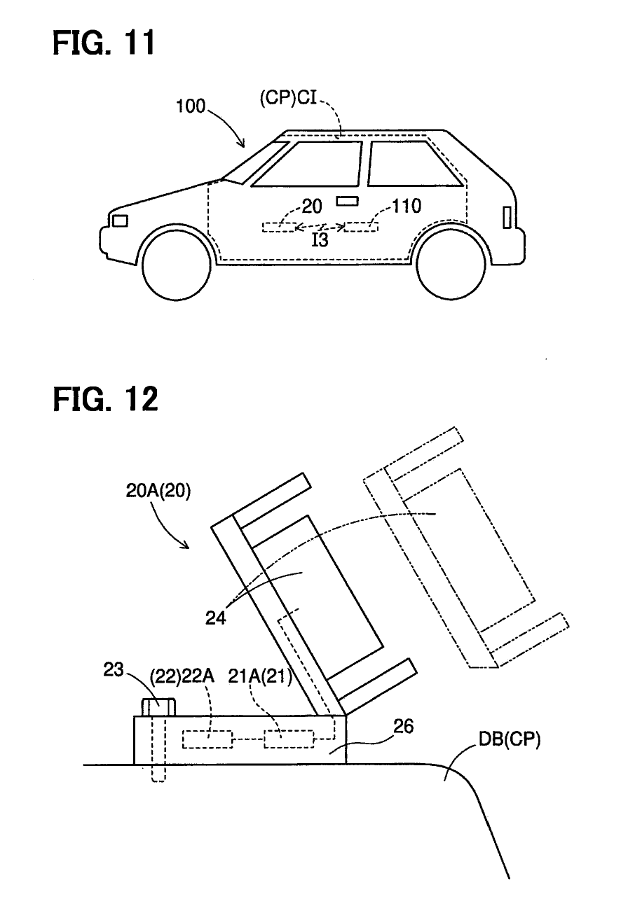

In the foregoing embodiments, as shown in FIG. 1 and FIG. 9, the transmitter 20 is fixed to the dashboard DB of the vehicle 100. That is, the predetermined portion CP to which the transmitter 20 is fixed is provided by the dashboard DB. Under a condition that the transmitter 20 is communicable with the portable terminal 30, the transmitter 20 may be fixed to a different internal portion that is a portion disposed inside of a compartment CI of the vehicle 100. For example, as shown in FIG. 11, the transmitter 20 may be fixed to an internal portion of a door. As another example, the transmitter 20 may be fixed to a seat, a floor of the compartment, an internal portion of a window glass, an internal pillar, an internal portion of a trunk, a roof of the compartment, a back mirror or the like. The predetermined portion CP may be properly set as a portion of the vehicle 100 under a condition that the transmitter 20 to be fixed to the vehicle 100 moves or stops integrally with the vehicle 100 and the accelerometer 22 is able to detect the acceleration of the vehicle 100. When the transmitter 20 is fixed to the above-described portions of the vehicle 100, similar advantages can be obtained with the foregoing embodiments.

As shown in FIG. 11, the transmitter 20 may be communicably connected with the ECU 110 via the wire communication or the wireless communication. In FIG. 11, the transmitter 20 transmits or receives the information I3 via a one-way communication or a two-way communication. The information I3 may include the vehicle related information, such as the vehicle manufacturer, the vehicle name, the vehicle number, the body color, a vehicle speed immediately before the vehicle collision occurs, an occurrence time of the vehicle collision. With this configuration, the vehicle related information I3 may be included in the emergency information to be reported to the report destination 50, and the vehicle related information I3 can be reported to the report destination 50.

In the first embodiment and in the third embodiment, as shown in FIG. 2 and FIG. 10, respectively, the transmitter 20A, 20C is integrally formed with the terminal holder 24. As another example, the terminal holder 24 may be formed separately from a main body 26 of the transmitter 20 as shown in FIG. 12. In this configuration, the terminal holder 24 is attachable to or removable from the main body 26 of the transmitter 20. In this configuration, the main body 26 of the transmitter 20 is fixed to the predetermined portion CP of the vehicle 100 via the fixing member 23. The terminal holder 24 may be attached to the main body 26 of the transmitter 20 via a proper attaching member. For example, one of the terminal holder 24 and the main body 26 may have a protruded portion, and the other of the terminal holder and the main body 26 may have a recessed portion so that the terminal holder 24 and the main body 26 engage with each other via the protruded portion and the recessed portion. When the terminal holder 24 is attached to the main body 26 of the transmitter 20, the configuration of the terminal holder 24 and the main body 26 is similar to the configuration described in the first embodiment and the third embodiment. When the terminal holder 24 is removed from the main body 26, the configuration of the terminal holder 24 and the main body 26 is similar to the configuration described in the second embodiment. The terminal holder 24 and the main body 26 having above-described configuration provide similar advantages with the configurations described in the first embodiment to the third embodiment.

In the first embodiment and in the third embodiment, the transmitter 20A, 20C transmits the acceleration information I1 to the portable terminal 30 as shown in FIG. 2. Further, when the portable terminal 30 is held by the terminal holder 24, the terminal holder 24 may be configured to charge the portable terminal 30. With this configuration, the portable terminal 30 has enough power storage to perform the emergency report, and a reliability of the emergency report is improved.

As shown in FIG. 2, each of the transmitting section 21A in the first embodiment and the transmitting section 21C in the third embodiment has both the wire communication function and the wireless communication function. As another example, each of the transmitting section 21A in the first embodiment and the transmitting section 21C in the third embodiment may only have the wire communication function. With this configuration, the transmitting section 21A, 21C does not perform the wireless communication. Thus, processes executed at S11 to S13 of the information transmit process in FIG. 3 may be skipped. Further, processes executed at S20, S21 of the information report process in FIG. 3 may be skipped. During the portable terminal 30 is held by the terminal holder 24, the transmitting section 21 is able to transmit the acceleration information I1a to the portable terminal 30 via the wire signal, and the report section 33 is able to perform the emergency report.

In the foregoing embodiments, the portable terminal 30 includes the collision determination section 32 as shown in FIG. 1. As another example, the transmitter 20 may include the collision determination section 32. The collision determination section 32 determines whether the vehicle collision has occurred based on the acceleration detected by the accelerometer 22. When the collision determination section 32 is provided by an application or a program executed by a computer, the collision determination section 32 may be configured to be updatable, and the transmitting section 21 may transmit a result determined by the collision determination section 32. With this configuration, even though the portable terminal 30 does not have a memory or a function to include the collision determination section 32, the portable terminal 30 is able to report the emergency to the report destination 50.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An emergency report system comprising:
a transmitter including an accelerometer and a transmitting section, the accelerometer detecting an acceleration of a vehicle, and the transmitting section transmitting acceleration information including the acceleration detected by the accelerometer;
a fixing member fixing the transmitter to a predetermined portion of the vehicle; and
a portable terminal including a receiving section and a report section, the receiving section receiving the acceleration information transmitted from the transmitting section, and the report section reporting, based on the acceleration information, an emergency to a report destination that is preliminarily stored in the portable terminal.

2. The emergency report system according to claim 1,
wherein the portable terminal further includes a collision determination section,
wherein the collision determination section determines that a collision of the vehicle is occurred when the acceleration included in the acceleration information is greater than a threshold value,
wherein the report section reports the collision of the vehicle as the emergency to the report destination, and
wherein the threshold value is set greater than a brake acceleration that is detected when a brake is applied to the vehicle.

3. The emergency report system according to claim 1,
wherein the report section inquires of a vehicle occupant of the vehicle whether to report the emergency,
wherein the report section determines the report destination based on a presence or an absence of a response from the vehicle occupant, and
wherein the report section reports the emergency to the report destination that is determined based on the presence or the absence of the response from the vehicle occupant.

4. The emergency report system according to claim 3,
wherein the report section selects the report destination based on the response from the vehicle occupant and reports the emergency to the report destination.

5. The emergency report system according to claim 1,
wherein the predetermined portion to which the transmitter is fixed is provided by a predetermined portion disposed in a compartment of the vehicle.

6. The emergency report system according to claim 1,
wherein the transmitter further includes a terminal holder that holds the portable terminal, and
wherein the transmitting section of the transmitter is communicably connected with the portable terminal when the portable terminal is held by the terminal holder.

7. The emergency report system according to claim 6,
wherein, when the portable terminal is held by the terminal holder, each of the receiving section and the report section is in an operating state even though a power of the portable terminal is turned off.

8. The emergency report system according to claim 6,
wherein the transmitting section performs a wire communication with the portable terminal when the portable terminal is held by the terminal holder, and
wherein the transmitting section performs a wireless communication with the portable terminal when the portable terminal is removed from the terminal holder.

9. The emergency report system according to claim 1, further comprising
at least one additional accelerometer, each of the accelerometer and the at least one additional accelerometer having a detection range different from one another,
wherein the transmitting section transmits the acceleration information including one of accelerations detected by the accelerometer and the at least one additional accelerometer.

10. The emergency report system according to claim 1, further comprising
a position information acquiring section acquiring position information indicating a present position of the vehicle,
wherein the report section reports the position information acquired by the position information acquiring section to the report destination.

11. The emergency report system according to claim 1,
wherein the accelerometer is provided by a two-axis accelerometer or a three-axis accelerometer.

12. The emergency report system according to claim 1,
wherein, when the transmitter performs a wireless communication, the transmitter further includes an audio section that outputs an audio signal.
